(19) United States
(12) Patent Application Publication
(10) Pub. No.: US 2005/0094639 A1
(43) Pub. Date: May 5, 2005

(54) Voice communication system, communications apparatus of the voice communication system, and service providing method using the voice communication system

(75) Inventor: Kazuhiko Miyazaki, Hino-shi (JP)

Correspondence Address: Finnegan, Henderson, Farabow,;Garrett & Dunner, L.L.P., 1300 I Street, N.W., Washington, DC, 20005-3315, US

(73) Assignee: KABUSHIKI KAISHA TOSHIBA

(21) Appl. No.: 10/974,034

(22) Filed: Oct. 27, 2004

(30) Foreign Application Priority Data
Oct. 31, 2003 (JP) 2003-373621

(51) Int. Cl. H04L 12/56

(52) U.S. Cl. 370/389

(57) ABSTRACT

A voice communication system includes a network which transmits a plurality of voice packets, a communication apparatus to communicate with an analog telephone terminal processing voice signal together with the network, convert the voice signal into the voice packets, and convert the voice packets into the voice signal, and a measurement circuit to measure voice quality of a received voice signal converted by communication apparatus, when voice communication using the network is being performed.

### CROSS-REFERENCE TO RELATED APPLICATIONS

This application is based upon and claims the benefit of priority from prior Japanese Patent Application No. 2003-373621, filed Oct. 31, 2003, the entire contents of which are incorporated herein by reference.

### BACKGROUND OF THE INVENTION

1. Field of the Invention

The present invention relates to a system for performing voice communication across a Voice Over Internet Protocol (VOIP) network that transmits voice packets. More particularly, the invention relates to a voice communication system having enhanced in voice communication service function, a communication apparatus of the voice communication system, and a service providing method using the voice communication system.

2. Description of the Related Art

In recent years, network telephony systems (IP telephony systems) that perform bidirectional realtime transmission/reception of images and voice in the form of packet data across packet networks have begun to find widespread used.

In an IP telephony system of the above-described type, IP telephone terminals are connected to a packet network, and the packet network is connected to a general telephone network, such as a public network, through a gateway. In the configuration, functions such as protocol conversion and data format conversion are executed in the IP telephone terminal and the gateway whereby to enable voice communication between the IP telephone terminals and between the IP telephone terminal and the general telephone network. The IP telephone terminal is configured by a cable modem connected to the packet network, and an analog telephone terminal connected to the cable modem.

In the IP telephony system, voice signals of low compression rates are handled when communication of highest possible quality is desired, whereas voice signals of high compression rates are handled when communication at a lowest possible fee is desired. When handling high quality voice signals, the voice quality should be monitored to prevent degradation thereof. Conventionally, there has been proposed a method in which a test IP packet is used to monitor the traffic state of a packet network whereby to monitor the voice quality (for example, Jpn. Pat. Appln. KOKAI Publication No. 2002-164918).

In the above method, however, problems occur in that a dedicated monitor device should be connected to an IP telephone terminal thereby making the configuration of the IP telephone terminal large and expensive.

### BRIEF SUMMARY OF THE INVENTION

An object of the present invention is to provide a voice communication system capable of monitoring the quality of voice signals that are reproduced on the side of a terminal without using a dedicated monitor device, a communication apparatus of the voice communication system, and a service providing method using the voice communication system.

According to an aspect of the present invention, there is provided a voice communication system comprising: a network which transmits a plurality of voice packets; a communication apparatus to communicate with an analog telephone terminal processing voice signal together with the network, convert the voice signal into the voice packets, and convert the voice packets into the voice signal; and a measurement circuit to measure voice quality of a received voice signal converted by communication apparatus, when voice communication using the network is being performed.

According to another aspect of the present invention, there is provided a communication apparatus to communicate with an analog telephone terminal processing voice signal together with a network which transmits a plurality of voice packets, convert the voice signal into the voice packets, and convert the voice packets into the voice signal, the communication device comprising a measurement circuit to measure voice quality of a received voice signal converted by the network, when voice communication using the network is being performed.

According to yet another aspect of the present invention, there is provided a service providing method using a voice communication system comprising a network which transmits a plurality of voice packets; a communication apparatus to communicate with an analog telephone terminal processing voice signal together with the network, convert the voice signal into the voice packets, and convert the voice packets into the voice signal; and a server apparatus to be connected to the communication apparatus via the network, the method comprising: measuring voice quality of a received voice signal converted by the communication apparatus, when voice communication using the network is being performed; reporting a measurement result of the voice quality to the server apparatus; and providing a service corresponding to the measurement result to a user of the communication apparatus in the server apparatus.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic configuration view showing a first embodiment of a voice communication system according to the present invention;

FIG. 2 is a block diagram showing a functional configuration of a cable modem shown in FIG. 1;

FIG. 3 is a block diagram showing a practical configuration of a voice processing section shown in FIG. 2;

FIG. 4 is a view showing a transmission/reception format of a voice packet according to the first embodiment;

FIG. 5 is a transmission/reception format of a measurement result of voice quality according to the first embodiment;

FIG. 6 is a block diagram showing a functional configuration of a network connecting device shown in FIG. 1;

FIGS. 7A and 7B are views showing per-communication-time measurement results;

FIG. 8 is a flowchart representing a measurement process operation of the cable modem according to the first embodiment;

FIG. 9 is a block diagram showing a connection configuration between a network connecting device and a cable modem according to a second embodiment of the present invention;

FIG. 10 is a sequence diagram showing a signal process operation between the network connecting device and the cable modem according to the second embodiment;

FIG. 11 is a view showing per-communication-time measurement results of a subscriber having a contract for high-quality communication;

FIG. 12 is a sequence diagram showing another signal process operation between the network connecting device and the cable modem according to the second embodiment; and

FIG. 13 is a view showing measurement results in units of communication time of a subscriber having a contract without communication quality conditions.

### DETAILED DESCRIPTION OF THE INVENTION

Embodiments of the present invention will be described in detail below with reference to the drawings.

(First Embodiment)

FIG. 1 is a schematic configuration view showing a first embodiment of a voice communication system according to the present invention. In FIG. 1, Reference symbols 1A and 1B each represent a network connecting apparatus (hereafter referred to as a “connecting apparatus”), such as a cable modem termination system (CMTS) serving as a server apparatus, owned by a service provider side. Reference symbols 2A and 2B each represent a VOIP cable modem, and reference symbols 3A and 3B each represent an analog telephone set. The connecting apparatus 1A and 1B are interconnected via an Internet INW. Coaxial cables 4A and 4B, such as radio frequency interfaces (RFI) respectively connect between the connecting apparatus 1A and the cable modem 2A, and between the connecting apparatus 1B and the cable modem 2B.

The connecting apparatuses 1A and 1B connect between the Internet INW and the respective coaxial cables 4A and 4B, respectively, and each have a function of converting a communication protocol and a signal format between the Internet INW and the coaxial cable 4A, 4B.

The cable modem 2A connects between a telephone set 3A and the coaxial cable 4A, and has a function of converting a communication protocol and a signal format between the telephone set 3A and the coaxial cable 4A. The cable modem 2B connects between a telephone set 3B and the coaxial cable 4B, and has a function of converting a communication protocol and a signal format between the telephone set 3B and the coaxial cable 4B.

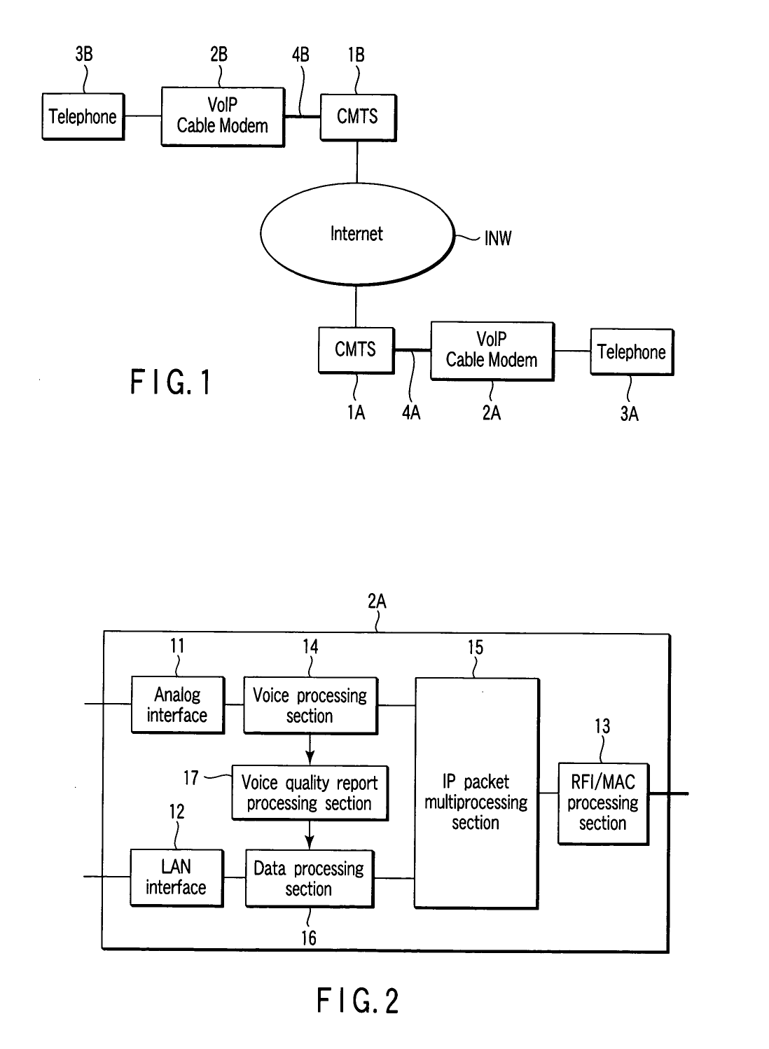

FIG. 2 is a block diagram showing a practical configuration of the cable modem 2A used as a communication apparatus of the present invention. The cable modems 2A and 2B have the same configuration, so that only the cable modem 2A will be representatively described below.

The cable modem 2A has an analog interface 11, a LAN interface 12, an RFI/MAC processing section 13, a voice processing section 14, an IP packet multiprocessing section 15 (hereinafter, “multiprocessing section 15”), a data processing section 16, and a voice quality report processing section 17 (hereinafter, “report processing section 17”).

The telephone set 3A is connected to the analog interface 11. A personal computer or the like is connected to the LAN interface 12 through a local area network (LAN). The coaxial cable 4A is connected to the RFI/MAC processing section 13.

A voice signal received through the analog interface 11 is formulated into IP/RTP (real-time protocol) packets and transmitted to the coaxial cable 4A through the multiprocessing section 15 and the RFI/MAC processing section 13. Voice packets received in the RFI/MAC processing section 13 are supplied to the voice processing section 14 through the multiprocessing section 15, reproduced into an analog voice signal by the voice processing section 14, and then transmitted to the telephone set 3A.

On the other hand, data packets other than the voice packets is received through the LAN interface 12 and transmitted to the coaxial cable 4A through the data processing section 16, the multiprocessing section 15, and the RFI/MAC processing section 13. Additionally, non-voice packets received through the coaxial cable 4A are transmitted to a personal computer or the like through the RFI/MAC processing section 13, the multiprocessing section 15, the data processing section 16, and the LAN interface 12.

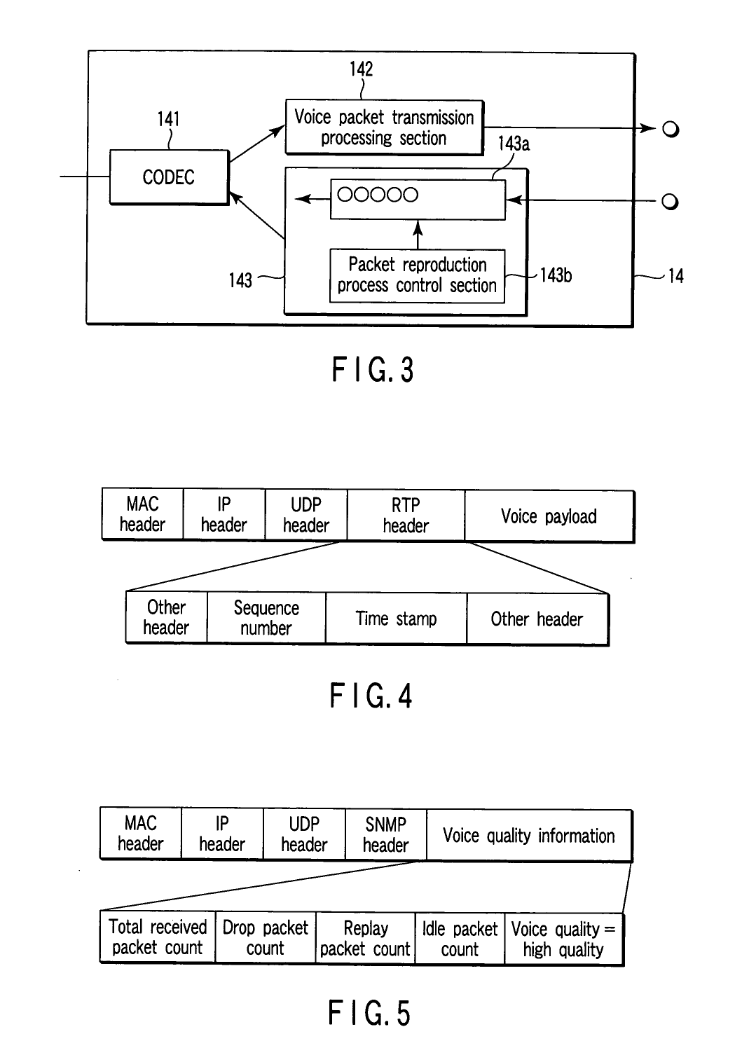

FIG. 3 is a block diagram showing a practical configuration of the voice processing section 14.

The voice processing section 14 has a coder/decoder (CODEC) 141, voice packet transmission processing section 142 (hereinafter, “transmission processing section 142”), and a voice packet reception processing section 143 (hereinafter, “reception processing section 143”). The analog voice signal, which has been input, is converted into a digital audio stream by the CODEC 141, formulated by the transmission processing section 142 into IP/RTP packets, and transmitted. At this time, as is shown in FIG. 4, in the transmission processing section 142, a sequence number, a time stamp, and the like are added to a header of the RTP in accordance with an RTP protocol.

The reception processing section 143 has a reproduction wait queue 143a (hereinafter, “wait queue section 143a”) and a packet reproduction process control section 143b (hereafter, “control section 143b”). The voice packets received through the coaxial cable 4A are temporarily preserved in the wait queue section 143a of the reception processing section 143. Before initiation of communication, the control section 143b reproduces the voice packets at a predetermined interval into a digital audio stream such as a PCM digital audio stream. The digital audio stream is converted by the CODEC 141 into a voice signal.

When the communication is under way, the voice processing section 14 has a function of measuring the voice quality of each of a transmitted voice signal and a received voice signal for the telephone set 3A. More specifically, in the event of reproduction of the voice packet at a predetermined interval into a digital audio stream such as a PCM digital audio stream, the voice processing section 14 monitors the sequence numbers of RTP headers of received voice packets. When the sequence number of a received voice packet is not continuous to the sequence number of a previously reproduced voice packet, packet loss has occurred, and a dropped packet counter is incremented. In this case, a packet to be reproduced is not present and hence a voice packet cannot be reproduced within the predetermined interval, so that the previously reproduced voice is reproduced again. Thus, the previous replay packet is reproduced again, whereby continuity of voice can be maintained and irregular flow of the voice being listened on the receiving side can be alleviated. In this event, the voice processing section 14 increments a replay packet counter.

In the voice processing section 14, the voice packets are thus reproduced into the digital audio stream at the predetermined interval. In addition, the voice processing section 14 transmits idle noise as voice when a voice packet to be reproduced does not arrive within the predetermined interval and is not stored in the reproduction wait queue because of delay or the like on the network. Thus, the idle noise is fed when a voice packet to be reproduced is not present in order to alleviate annoyance due to irregular flow of voice listened on the receiving side. When such an event has occurred, the voice processing section 14 increments the idle packet counter.

As described above, when various events degrading the voice quality have occurred, the voice processing section 14 is capable of counting the number of drop packets, replay packets, and idle packets at the time of communication completion. In this way, the quality of actually performed communication can be measured and determined in accordance with the thus-known dropped packet count, replay packet count, and idle packet count.

As an example, the voice processing section 14 has a function capable of making quality determination in accordance with measurements in the following manner. If the total packet count of the dropped packet count, idle packet count, and replay packet count is 10% or less than the total voice packet count of the dropped packet count, idle packet count, and Replay packet count, the communication is determined to be of high quality; if 10% to 30%, the communication is determined to be of normal quality; and if 30% or higher, the communication is determined to be of low quality.

The voice processing section 14 does not use packets of special formats, but uses only widely used RTP packets as means for performing the voice quality measurement and determination. There is another advantage in that the voice quality measurement and determination can be implemented even when a remote communication end does not have a special function dedicated to perform the voice quality measurement.

The voice quality measurement result is supplied to the report processing section 17. The report processing section 17 creates the data packets including voice quality information, as shown in FIG. 5, and transmits the information to the coaxial cable 4A via the data processing section 16, the multiprocessing section 15, and the RFI/MAC processing section 13. The data packets are supplied to the connecting apparatus 1A and processed.

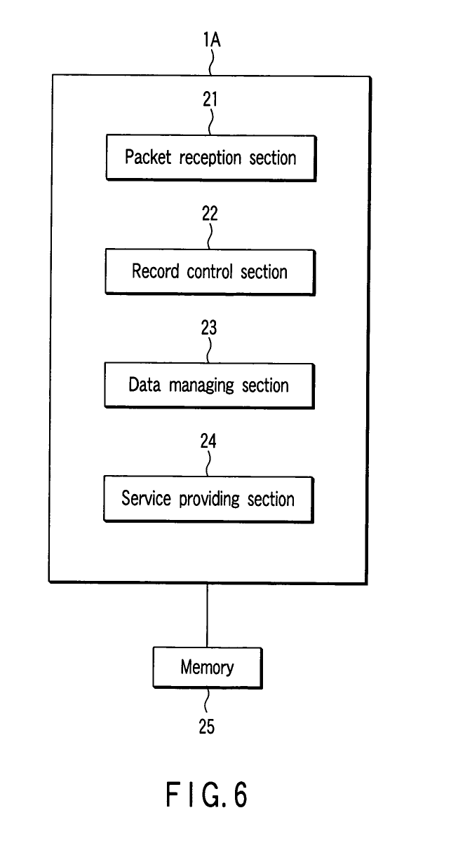

FIG. 6 is a block diagram showing a functional configuration of the connecting apparatus 1A and 1B. The connecting apparatus 1A and 1B have the same configuration, so that only the connecting apparatus 1A will be representatively described below.

The connecting apparatus 1A has a packet reception section 21, a record control section 22, a data managing section 23, a service providing section 24, and a memory 25. The packet reception section 21 receives a report from the cable modem 2A, and receives data packets including voice quality measurement information therefrom. The record control section 22 records the voice quality measurement information contained in the data packets in the memory 25.

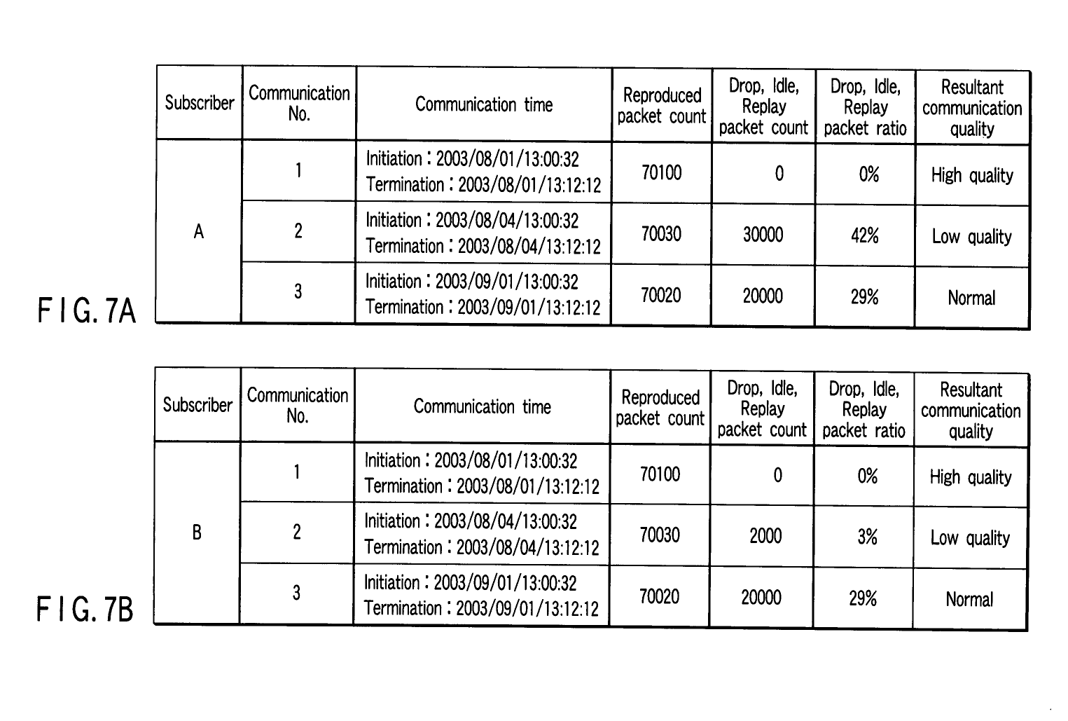

As shown in FIG. 7, the data managing section 23 manages measurement information in the memory 25 in correlation with identification information representing the cable modem 2A in units of communication time. The service providing section 24 provides services corresponding to the measurement information to a user of the cable modem 2A.

Voice communication operation of the system configured as described above will raw be described.

A basic communication connection process will first be described.

Telephone sets 3A and 3B are individually assigned, for example, telephone numbers as terminal identification information. The telephone numbers are stored in the respective connecting apparatus 1A and 1B. Additionally, routine information used to determine a receiving end at the time of reception of a call from the internet INW are stored in the connecting apparatuses 1A and 1B.

A case is now assumed in which a caller of the telephone set 3B has dialed “050-XXX-1234” on the telephone set 3B to perform voice communication with the telephone set 3A connected to the cable modem 2A. In response, an incoming signal is transmitted to the connecting apparatus 1A from the internet INW. Having received the incoming signal, the connecting apparatus 1A refers to (accesses) routine information, and thereby transmits a connection request signal to the telephone set 3A corresponding to the “050-XXX-1234” via the coaxial cable 4A.

A sound is generated at the telephone set 3A having received the connection request signal, thereby to notify the user of the occurrence of the incoming call. When the user performs a response operation in response to the incoming-call report, the telephone set 3A responsively transmits a connection response signal to the requesting-source connecting apparatus 1A. Having received the connection response signal, the connecting apparatus 1A transmits a response signal to the internet INW. Thereby, a communication path is formed between the transmission-source the telephone set 3B and the receiving-end telephone set 3A, thereafter enabling voice communication between the two telephone sets 3A and 3B.

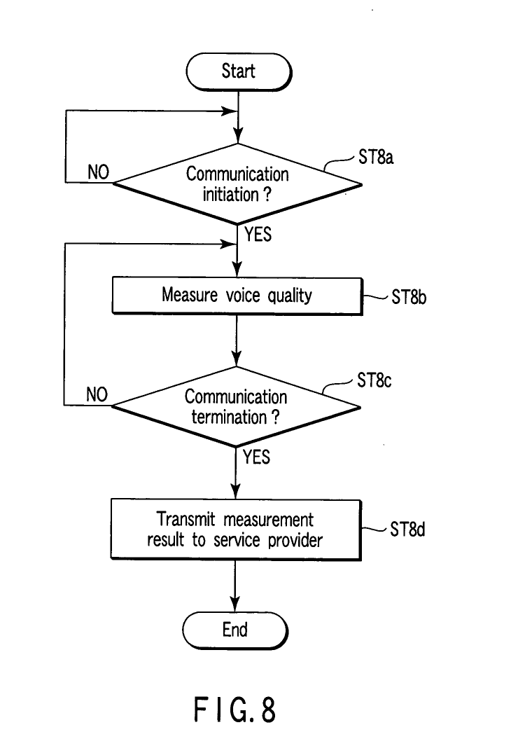

A voice quality measurement process in the cable modem 2A will be described hereinafter. FIG. 8 is a flowchart representing a measurement process operation of the cable modem 2A.

The cable modem 2A continuity monitors whether or not the system has entered the state of communication initiation (step ST8a). When the system has entered the state of communication initiation (Yes), the process performs the measurement of the voice quality of each of a transmitted voice signal and a received voice signal (step ST8b). Then, the process monitors whether or not the communication terminates (step ST8c), and iterates the processings of steps ST8b and ST8c until the communication terminates.

Upon termination of the communication, the cable modem 2A inserts measurement results into a data packets conforming to an simple network management protocol (SNMP), and transmits the data packet to the connecting apparatus 1A (step ST8d).

The connecting apparatus 1A performs a process for reflecting the notified voice quality measurement results in services. For example, when the voice quality is low, a high-quality communication basic fee amount under a contract for the transmission-source cable modem 2A is discounted by a predetermined amount, or a communication fee amount to be added to a basic charge amount is discounted by a predetermined amount in accordance with the measurement results.

A discount reflection process of the type described above is executed each time a voice quality measurement result arrives, and a history log of the process is accumulated.

On a billing date, a bill is created in accordance with accumulated history log information of discount reflection processes, and the bill is sent to the user of the cable modem 2A. Methods of sending the bill include a method of sending by facsimile or as an attached file of electronic mail or by postal delivery.

Thus, according to the first embodiment, in the state where communication using the coaxial cable 4A is under way in the telephone set 3A, the voice quality of each of the received voice signal and the transmitted voice signal is measured using the cable modem 2A.

Therefore, the voice quality measurement can be implemented using a conventional cable modem 2A. Accordingly, a dedicated monitor device need not be additionally provided to connect the device to the cable modem 2A; and in addition, the voice quality measurement can be implemented without using special test packets, so that potential cost increase can be prevented.

According to the first embodiment, the voice quality measurement results are reported to the connecting apparatus 1A on the service providing side. In the connecting apparatus 1A, the communication qualities of the individual cable modems 2A are stored in the form of a database in order to enable acquisition and management of the communication quality states of the cable modems 2A which are used by subscribers.

Consequently, a service provider owning the connecting apparatus 1A is enabled to change fee schedules depending on differences in communication qualities that are provided by the service provider and is enabled to soon discover an abnormal portion of the system, thereby enabling quick troubleshooting.

Further, according to the first embodiment, in the event that, in accordance with voice quality measurement results reported from the cable modem 2A, the voice quality is low for a service provided to the user of the cable modem 2A having a contract for high quality communication, profits corresponding thereto are returned to the user of the cable modem 2A in the manner of a communication fee discount.

Consequently, the user of the cable modem 2A can receive services corresponding to the voice quality measurement results, and the service provider can promote service user subscription.

(Second Embodiment)

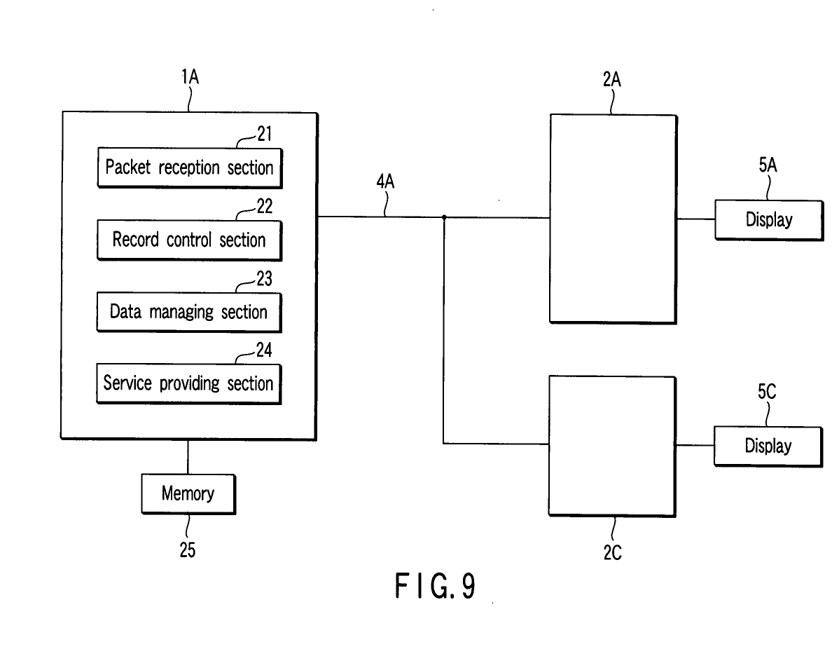

FIG. 9 is a block diagram showing a connection configuration between the connecting apparatus 1A and cable modems 2A and 2C in accordance with a second embodiment of the present invention. Thus, the additional cable modem 2C is connected to the coaxial cable 4A.

In addition, in response to a communication record request received from each of the cable modems 2A and 2C, the data managing section 23 transmits communication record information including voice quality measurement results, which are managed in the memory 25, to the requesting source.

Further, displays 5A and 5C are connected to the cable modems 2A and 2C, respectively. The communication record information transmitted from the connecting apparatus 1A is displayed on the displays 5A and 5C.

A voice communication operation of the system thus configured will now be described.

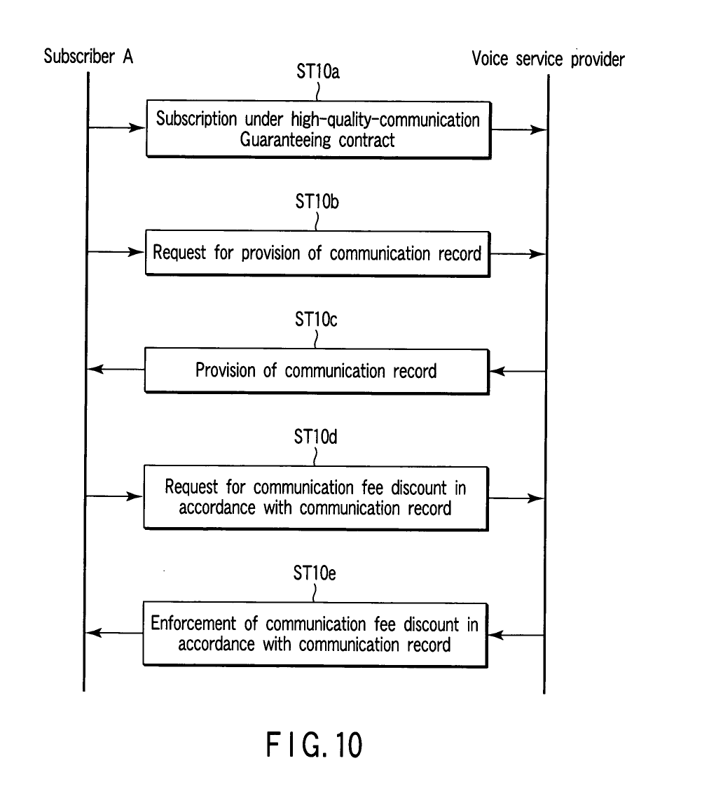

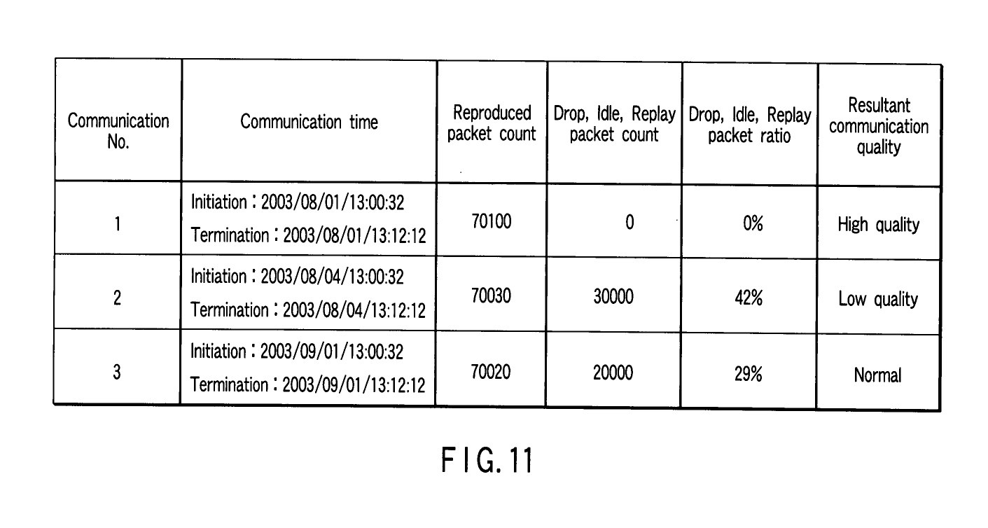

FIG. 10 is a sequence diagram showing a signal process operation between the connecting apparatus 1A and the cable modem 2A.

To begin with, a user of the cable modem 2A is assumed to have a service contract for guaranteed high-quality communication with a service provider (step ST10a). The user of the cable modem 2A performs voice communication, in which if the user has felt voice quality of the communication to be unsatisfactory, he/she transmits a communication record request to the connecting apparatus 1A on the service provider side (step ST10b).

Upon receipt of information of the request from the cable modem 2A, the connecting apparatus 1A reads communication record information, as shown in FIG. 11, corresponding to the cable modem 2A from the memory 25, and transmits the communication record information to the requesting-source cable modem 2A (step ST10c). In response, the cable modem 2A receives the communication record information and in turn supplies the information to the display 5A so that the information is displayed thereon. The display of the information enables the user to verify communication record contents.

In this state, a case is now assumed in which the user has determined the resultant communication quality to be not high quality, as in Communication 3, and has hence input a transmission instruction for discount request information, which requests a corresponding communication fee discount. Then, the cable modem 2A transmits the discount request information to the connecting apparatus 1A (step ST10d).

Upon receipt of the discount request information from the cable modem 2A, the connecting apparatus 1A enforces communication fee discount in accordance with the discount request information (step ST10e).

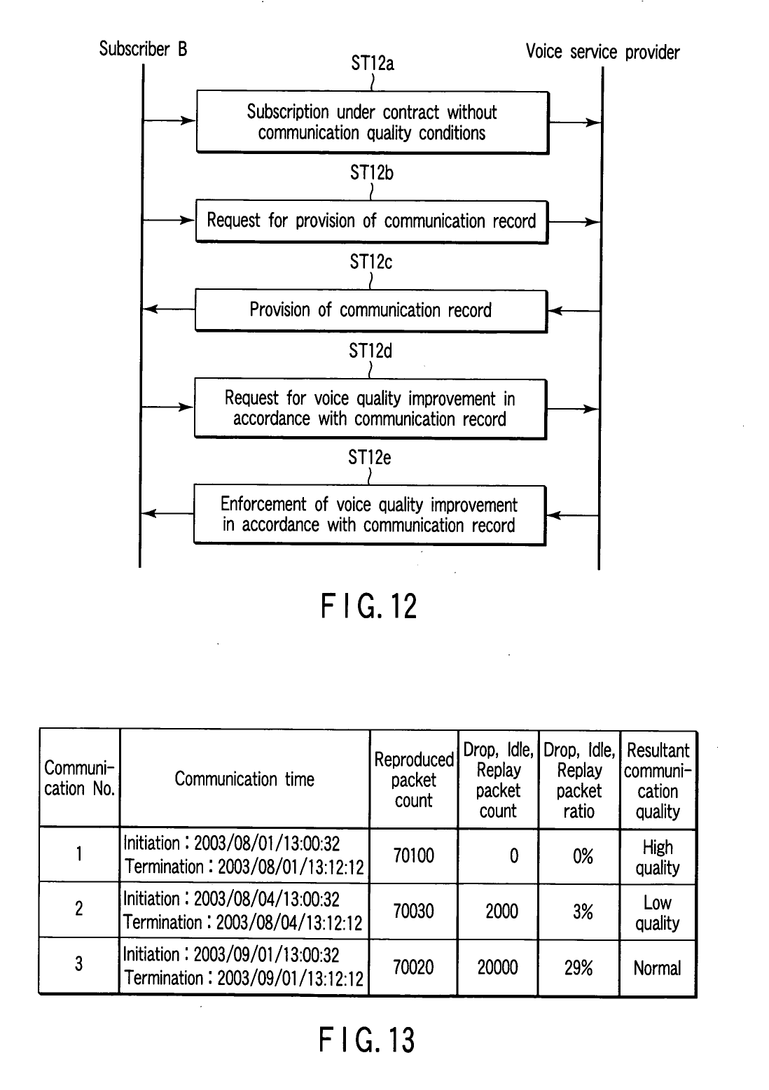

FIG. 12 is a sequence diagram showing a signal process operation between the connecting apparatus 1A and the cable modem 2C.

First, a user of the cable modem 2C is assumed to have concluded a service contract without communication quality conditions with a service provider (step ST12a). The user of the cable modem 2C performs voice communication, in which if the user has felt voice quality of the communication being unsatisfactory, he/she transmits a communication record request to the connecting apparatus 1A on the service provider side (step ST12b).

Upon receipt of information of the request from the cable modem 2A, the connecting apparatus 1A reads communication record information, as shown in FIG. 13, corresponding to the cable modem 2C from the memory 25, and transmits the communication record information to the requesting-source cable modem 2C (step ST12c). Then, the cable modem 2C receives the communication record information and in turn supplies the information to the display 5C so that the information is displayed thereon. The display of the information enables the user to verify communication record contents.

In this state, a case is now assumed in which the user has determined the resultant communication quality to be extremely low, as in Communication 2, or low quality communication has frequently occurred, and has hence input a transmission instruction for improvement request information, which requests for voice quality improvement. Then, the cable modem 2C transmits the improvement request information to the connecting apparatus 1A (step ST12d).

Upon receipt of the improvement request information from the cable modem 2C, the connecting apparatus 1A enforces system improvement to improve the communication quality in accordance with the improvement request information (step ST12e).

Thus, according to the second embodiment, in response to the request, the display 5A, 5C displays the measurement result of the voice quality regarding the cable modem 2A, 2C being managed by the connecting apparatus 1A, and services corresponding to the measurement results are executed according to the instructions issued by the user. Accordingly, the user herself or himself can verify the voice quality when communication is performed, whereby quality improvement can be requested to the service provider when the user has felt an abnormality.

Further, according to the second embodiment, in the event that, in accordance with voice quality measurement results reported from the cable modem 2A, 2C, the voice quality is low for the service provided to the user of the cable modem 2A having a contract for high quality communication, profits corresponding thereto are returned to the user of the cable modem 2A in the manner of communication fee discount. On the other hand, for the user of the other cable modem 2C, when the voice quality is low, the communication quality is improved.

Consequently, the user of the cable modem 2A, 2C can receive services corresponding to the voice quality measurement results, and the service provider can promote service user subscription.

(Other Embodiments)

The present invention is not limited to the individual embodiments described above. While the embodiments have each been described with reference to the example in which the means for measuring the voice quality is provided inside the cable modem, the means may be provided outside the cable modem.

In addition, the each embodiment has been described with reference to the example in which the services corresponding to the measurement results are provided by the network connecting apparatus. However, the present invention is not limited to the example, and the service provision may be enforced using, for example, the server apparatus connected to the internet or by the provider.

Further, while the each embodiment has been described with reference to the example using the cable modem, a communication apparatus other than the cable modem, such as a gateway may be used.

Furthermore, the present invention may be enforced by variously modifying, for example, the type and configuration of the system, the configuration of the cable modem, the type of the telephone set, the voice quality measurement method, and the service contents without departing from the spirit and scope of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A voice communication system comprising:
a network which transmits a plurality of voice packets;
a communication apparatus to communicate with an analog telephone terminal processing voice signal together with the network, convert the voice signal into the voice packets, and convert the voice packets into the voice signal; and
a measurement circuit to measure voice quality of a received voice signal converted by communication apparatus, when voice communication using the network is being performed.

2. A voice communication system according to claim 1, when time information is added to received voice packets, wherein the measurement circuit measures voice quality of the received voice signal based on the time information.

3. A voice communication system according to claim 2, wherein the measurement circuit measures at least one of the number of lost voice packets, the number of packets repeatedly reproduced from voice packets occurring before lost packets, and the number of packets indicative of noise based on the time information.

4. A voice communication system according to claim 1, wherein the measurement circuit is provided in the communication apparatus.

5. A voice communication system according to claim 1, further comprising:
a server apparatus to be connected to the network; and
a reporting circuit to report a measurement result of the voice quality to the server apparatus.

6. A voice communication system according to claim 5, wherein the server apparatus comprises:
a recorder which records the reported measurement result of the voice quality into a recording medium; and
a controller which controls to manage the measurement result in the recording medium in units of a communication time by correlating the measurement result to identification information representing the communication apparatus.

7. A voice communication system according to claim 6, wherein the controller comprises a presentation circuit to transmit the measurement result in the recording medium in units of the communication time to the communication apparatus in order to present the measurement result, in response to a request from the communication apparatus.

8. A voice communication system according to claim 5, wherein the server apparatus comprises a providing circuit to provide a service corresponding to the measurement result to a user of the communication apparatus.

9. A voice communication system according to claim 8, wherein the providing circuit performs at least one of discount of a fee of voice communication by the user of the communication apparatus and voice quality improvement in accordance with the measurement result.

10. A communication apparatus to communicate with an analog telephone terminal processing voice signal together with a network which transmits a plurality of voice packets, convert the voice signal into the voice packets, and convert the voice packets into the voice signal, the communication apparatus comprising
a measurement circuit to measure voice quality of a received voice signal converted by the network, when voice communication using the network is being performed.

11. A communication apparatus according to claim 10, when time information is added to received voice packets, wherein the measurement circuit measures voice quality of the received voice signal based on the time information.

12. A communication apparatus according to claim 11, wherein the measurement circuit measures at least one of the number of lost voice packets, the number of packets repeatedly reproduced from voice packets occurring before lost packets, and the number of packets indicative of noise based on the time information.

13. A service providing method using a voice communication system comprising a network which transmits a plurality of voice packets; a communication apparatus to communicate with an analog telephone terminal processing voice signal together with the network, convert the voice signal into the voice packets, and convert the voice packets into the voice signal; and a server apparatus to be connected to the communication apparatus via the network,
the method comprising:
measuring voice quality of a received voice signal converted by the communication apparatus, when voice communication using the network is being performed;
reporting a measurement result of the voice quality to the server apparatus; and
providing a service corresponding to the measurement result to a user of the communication apparatus in the server apparatus.
